(19) United States
(12) Patent Application Publication
(10) Pub. No.: US 2009/0314611 A1
(43) Pub. Date: Dec. 24, 2009

(54) RECONFIGURABLE TRANSPORT SYSTEM

(75) Inventors: Joseph A. Trudeau, Watertown, CT (US); Robert F. Marcinik, Wallkill, NY (US); Edward M. Ifkovits, New Fairfield, CT (US); Russell W. Holbrook, Southbury, CT (US); Richard Prochut, Southbury, CT (US)

Correspondence Address: PITNEY BOWES INC., 35 WATERVIEW DRIVE, MSC 26-22, SHELTON, CT, 06484-3000, US

(73) Assignee: Pitney Bowes Inc., Stamford, CT (US)

(21) Appl. No.: 12/142,966

(22) Filed: Jun. 20, 2008

(51) Int. Cl. B65G 15/06

(52) U.S. Cl. 198/617; 198/831

(57) ABSTRACT

A reconfigurable transport system includes a transport device for receiving items in a first orientation in one of a first portion and a second portion and releasing the items from the other of the first portion and the second portion. The transport device includes rotating transport elements in opposing relation. Items received between the transport elements are conveyed along a transport axis. The transport system further includes a positioning device for selectively moving the second portion between a first position in which the transport device maintains the items in the first orientation, and a second position in which the transport device rotates the items substantially about the transport axis to a second orientation.

### FIELD OF THE INVENTION

The present invention relates to a system for transporting items and, more particularly, to a reconfigurable transport system.

### BACKGROUND OF THE INVENTION

Inserter machines are used to create mailpieces for many different applications. Inserters contain a generally modular array of components to carry out the various processes associated with mailpiece creation. The processes include preparing documents, assembling the documents associated with a given mailpiece, adding any designated inserts, stuffing the assembly into an envelope, and printing information on the envelope.

A given arrangement of modular components is normally limited to handling a group of mailpieces requiring similar assembly and finishing, such as printing information on one side of the envelope, for example. Where a user desires to process a subsequent group of mailpieces differently, such as printing on the other side of the envelope, for example, it is often necessary to change out components of the inserter to accommodate those mailpieces.

### SUMMARY OF EXEMPLARY ASPECTS

In the following description, certain aspects and embodiments of the present invention will become evident. It should be understood that the invention, in its broadest sense, could be practiced without having one or more features of these aspects and embodiments. It should also be understood that these aspects and embodiments are merely exemplary.

In accordance with the purpose of the invention, as embodied and broadly described herein, one aspect of the invention relates to a reconfigurable transport system comprising a transport device for receiving items in a first orientation in one of a first portion and a second portion and releasing the items from the other of the first portion and the second portion.

In one embodiment, the transport device comprises at least one first transport element rotating around a plurality of first support rollers in a first direction and at least one second transport element in opposing relation to the at least one first transport element, the at least one second transport element rotating around a plurality of second support rollers in a second direction opposite to the first direction. Items received between the transport elements are conveyed along a transport axis.

As used herein, “items” include papers, documents, postcards, envelopes, brochures, enclosures, booklets, media items, including CDs, DVDs, computer disks, and/or other digital storage media, and packages having a range of sizes and materials.

Further, as used herein, “first portion” means the components of the transport device, including rollers and portions of the transport elements, proximate to a first end of the transport device. Further, as used herein, “second portion” means the components of the transport device, including rollers and portions of the transport elements, proximate to a second end of the transport device.

In other embodiments, the transport system further comprises a positioning device for selectively moving the second portion between a first position in which the transport device maintains the items in the first orientation, and a second position in which the transport device rotates the items substantially about the transport axis to a second orientation.

In another aspect, the invention relates to a reconfigurable transport system comprising a transport device for receiving items in a first orientation in one of the first portion and the second portion and releasing the items from the other of the first portion and the second portion, and a positioning device.

In one embodiment, the transport device comprises at least one first transport element rotating around a plurality of first support rollers in a first direction, wherein the plurality of first support rollers comprises a first end roller.

In another embodiment, the transport device further comprises at least one second transport element in opposing relation to the at least one first transport element, the at least one second transport element rotating around a plurality of second support rollers in a second direction opposite to the first direction, wherein the plurality of second support rollers comprises a second end roller. Items placed between the transport elements are conveyed along a transport axis.

In yet another embodiment, the transport system further comprises a housing supporting the transport device and the positioning device.

In a further aspect, the invention relates to a method of conveying items in a reconfigurable transport system. In one embodiment, the method comprises receiving the items in a first orientation in one of a first portion and a second portion of a transport device, conveying the items between the transport elements along a transport axis, selectively moving the second portion of the transport device between a first position in which the transport device maintains the items in the first orientation and a second position in which the transport device rotates the items substantially about the transport axis to a second orientation, and releasing the items from the other of the first portion and the second portion of the transport device.

According to an embodiment, the transport device comprises at least one first transport element rotating around a plurality of first support rollers in a first direction and at least one second transport element in opposing relation to the at least one first transport element, the at least one second transport element rotating around a plurality of second support rollers in a second direction opposite to the first direction.

Aside from the structural and procedural arrangements set forth above, the invention could include a number of other arrangements, such as those explained hereinafter. It is to be understood that both the foregoing description and the following description are exemplary only.

### BRIEF DESCRIPTION OF THE DRAWINGS

The accompanying drawings, which are incorporated in and constitute a part of this specification, illustrate an exemplary embodiment of the invention and, together with the description, serve to explain the principles of the invention. In the drawings,

FIG. 1 is a schematic view of an inserter system utilizing an embodiment of the reconfigurable transport system of the present invention;

FIG. 2 is a perspective view of an embodiment of the reconfigurable transport system of the present invention;

FIG. 3 is a cross-sectional view of the system shown in FIG. 2;

FIG. 4 is a partial perspective view of an embodiment of the positioning device according to the invention with the second portion of the transport device in the first position;

FIG. 5 is a partial perspective view of an embodiment of the positioning device according to the invention with the second portion of the transport device in one embodiment of the second position;

FIG. 6 is a partial perspective view of an embodiment of the positioning device according to the invention with the second portion of the transport device in another embodiment of the second position; and

FIG. 7 is a partial perspective view of an embodiment of the roller mounting assembly according to the invention.

### DETAILED DESCRIPTION OF EXEMPLARY EMBODIMENTS

Reference will now be made in detail to exemplary embodiments of the invention, examples of which are illustrated in the accompanying drawings. Wherever possible, the same reference numbers will be used throughout the drawings to refer to the same or like parts.

Embodiments of the reconfigurable transport system according the invention will be described with reference to certain applications in mailpiece inserter systems. It should be understood, however, that the device of the invention may be used in association with other systems configured to handle and transport items.

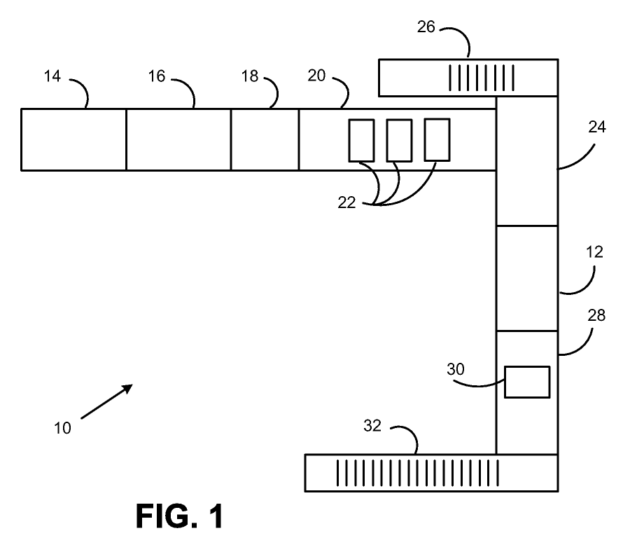

A schematic view of an inserter system 10 incorporating the reconfigurable transport system 12 of the invention is shown in FIG. 1. The illustrated exemplary inserter system 10 comprises a sheet feeder 14, which provides pre-printed documents for processing. The documents, which may comprise bills or financial statements, for example, may be provided by the sheet feeder 14 as individual “cut sheets,” or may be cut from a spool using a web cutter (not shown).

The documents next move to an accumulator 16, where the documents for respective mailpieces are assembled and folded. The folded accumulations next move to a buffer 18, which holds the accumulations for sequential processing. The accumulations next move to a chassis 20. As each accumulation moves through the chassis, inserts from a plurality of feeder modules 22 are added to the accumulation.

The accumulations next enter an insertion area 24, where the finished accumulations are stuffed into envelopes provided by an envelope hopper 26, and the envelopes are sealed. The stuffed, sealed envelopes next pass through the reconfigurable transport system 12 of the invention, as discussed in more detail below.

The envelopes then enter a printing area 28, where markings, such as a postage indicia and/or address information, for example, are applied using a printer 30. Finally, the completed mailpieces are deposited on a conveyor 32.

The reconfigurable transport system 12 of the present invention may allow a user to maintain a given orientation of items, such as mailpieces, for example, while transporting the items, or to selectively reorient the items while transporting them. The user's ability to selectively reorient items may increase the functionality and flexibility of item-handling systems, such as inserter systems, for example, by enabling systems having a given equipment configuration to process items differently without requiring a change of components.

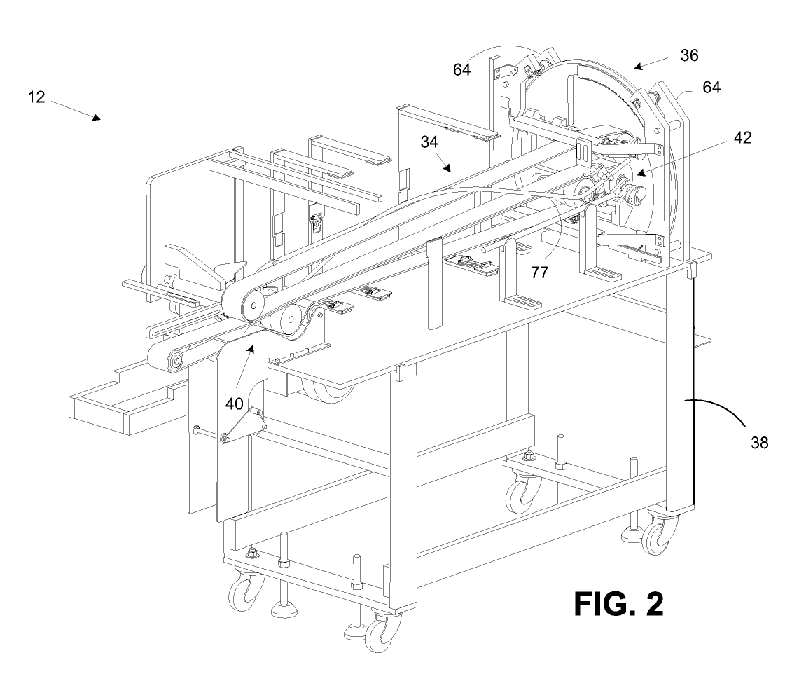

An embodiment of the reconfigurable transport system 12 of the invention is shown in FIG. 2. The system in the illustrated embodiment comprises a transport device 34, a positioning device 36, and a housing 38 supporting the transport device 34 and the positioning device 36. The transport device 34 receives items in a first orientation in one of a first portion 40 and a second portion 42 and releases the items from the other of the first portion 40 and the second portion 42.

In one embodiment, the items may be received in the first portion 40 from an upstream component of an item-handling system and released from the second portion 42 to a downstream component of the system. In another embodiment, the transport system 12 may be reoriented and the items may be received in the second portion 42 from an upstream component of an item-handling system and released from the first portion 40 to a downstream component of the system.

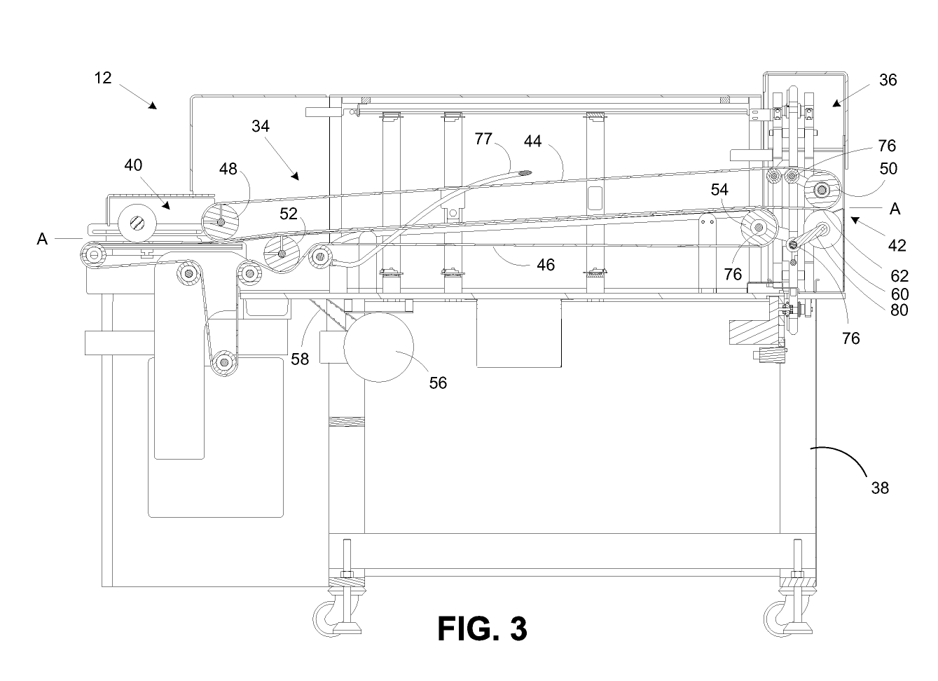

FIG. 3 provides a cross-sectional view of the system 12 shown in FIG. 2. As shown in FIG. 3, the transport device 34 comprises at least one first transport element 44 rotating around a plurality of first support rollers in a first direction and at least one second transport element 46 in opposing relation to the at least one first transport element 44, the at least one second transport element 46 rotating around a plurality of second support rollers in a second direction opposite to the first direction. Items received between the transport elements 44, 46 are conveyed along a transport axis A.

The direction of travel of the transport elements 44, 46 may be selected based on whether the first portion 40 or the second portion 42 of the transport device 34 is receiving the items.

In the illustrated embodiment, the at least one first transport element 44 and the at least one second transport element 46 each comprise a single belt. In one example, each belt is constructed of two compounds: a thin, high-durometer rubber on the drive side, which contacts the rollers, and a thick, low-durometer rubber, such as LYNATEX™, for example, on the opposite side, which contacts the opposing belt and the items being transported by the belts. Other materials may also be used. In addition, other arrangements of transport elements may be used. For example, a plurality of laterally spaced first transport elements and second transport elements may be used. In one example, the plurality of transport elements may comprise a plurality of belts or O-rings.

In the embodiment shown in FIG. 3, the plurality of first support rollers supporting the first transport element 44 comprises a first drive roller 48 and a first end roller 50. Similarly, the plurality of second support rollers supporting the second transport element 46 comprises a second drive roller 52 and a second end roller 54. The first drive roller 48 and the second drive roller 52 are driven by a single drive motor 56 employing a single drive belt 58. In one example, the drive motor comprises a ¼-horsepower AC electric motor. Other drive motors may also be used. The drive belt 58 drives the first drive roller 48 and the second drive roller 52 in opposite directions through a drive mechanism (not shown). The drive rollers 48, 52, in turn, drive the first transport element 44 and the second transport element 46, respectively, in counter-rotating loops.

In the embodiment shown in FIG. 3, the transport device 34 further comprises a nip roller 60 forming a nip 62 with the first end roller 50 for engaging items passing therebetween.

In some embodiments, all of the rollers in the system are mounted on cantilevered shafts to facilitate the repair and replacement of the transfer elements (e.g., belts) in the system.

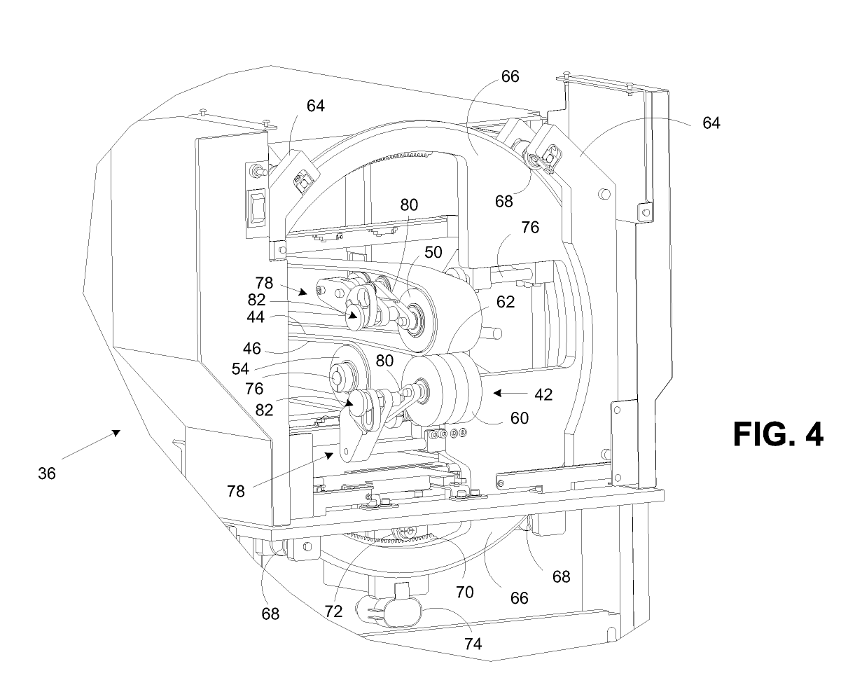

The system 12 further comprises a positioning device 36, shown in detail in FIGS. 4-6, for selectively moving the second portion 42 between a first position in which the transport device 34 maintains the items in the first orientation, and a second position in which the transport device 34 rotates the items substantially about the transport axis A to a second orientation. In the illustrated embodiment, the positioning device 36 comprises a stationary frame 64. In one embodiment, the frame 64 may be supported on the housing 38.

The positioning device 36 shown in FIGS. 4-6 further comprises a selectively rotatable guide 66 disposed on the frame 64. In one embodiment, the guide 66 is rotatably supported on the frame 64 by a plurality of support elements 68. The support elements 68 may comprise rollers having a shape that complements a chamfer on the outer edge of the guide 66. Other arrangements of support elements may also be used.

A first gear element 70 disposed on the guide 66 is engaged by a second gear element 72. In the illustrated embodiment, the first gear element 70 comprises a portion of an annular gear, in particular, an internal gear, and the second gear element 72 comprises a pinion. Other arrangements of gears may also be used.

A drive element 74 selectively drives the second gear element 72, which in turn drives the first gear element 70 to rotate the guide 66. In one example, the drive element 74 comprises a 1/100-horsepower AC electric motor. Other motors may also be used. In alternative embodiments, manual actuation may also be used.

In the illustrated embodiment, the first end roller 50, the second end roller 54, and the nip roller 60 are supported on the guide 66 on respective cantilevered shafts 76. Thus, as discussed above, rotation of the guide 66 moves the second portion 42 of the transport device 34, comprising at least the end rollers 50, 54, the nip roller 60, and portions of the transport elements 44, 46, between the first position and the second position. In one embodiment, the transport device 34 with the second portion 42 in the second position rotates the items approximately 180 degrees or less substantially about the transport axis A. In some embodiments, a removable guide bar 77, shown in FIG. 2 and shown in cross-section in FIG. 3, surrounding the transport elements 44, 46 may be used to guide the items as they are reoriented in the transport device 34.

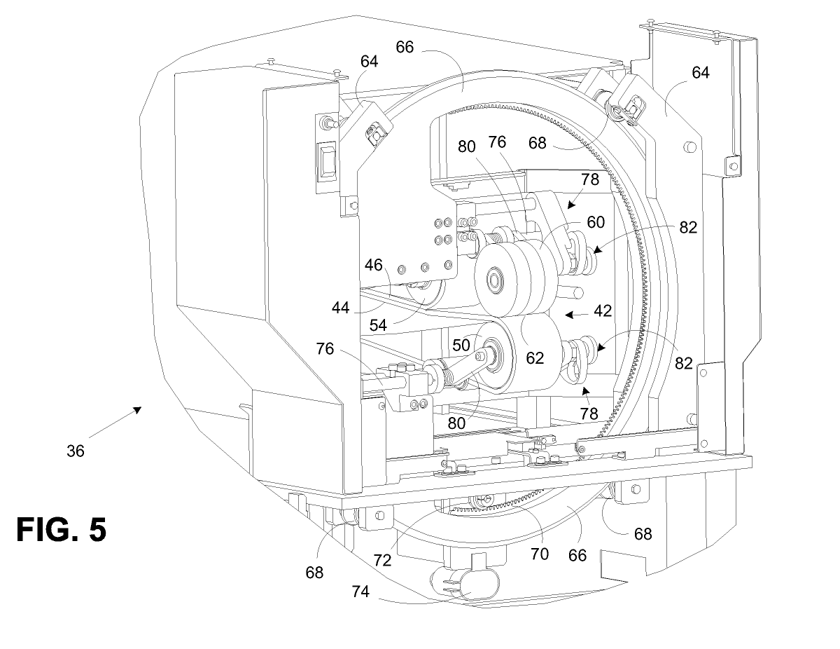

FIG. 5 shows the second portion 42 arranged to rotate the items approximately 180 degrees substantially about the transport axis A. Such an arrangement may have application where a user desires to invert an item being conveyed through an item-handling system.

In one example, with reference to the inserter system shown in FIG. 1, envelopes in the “face down” orientation are stuffed with accumulations in the insertion area 24. The downstream printer 30 is configured with downward facing print heads to print on the top surface of the passing envelopes. In order to print a postage indicia and/or address information, for example, on the front faces of the envelopes, the positioning device 36 is arranged as shown in FIG. 5, so that the envelopes are inverted by the transport device 34 and the front faces of the envelopes are presented to the print heads.

In order to print on the back faces of the envelopes using the same system, the positioning device 36 is arranged as shown in FIG. 4, so that the orientation of the envelopes is not changed. Thus, the envelopes are stuffed in the face down orientation and are passed straight through the transport system 12 to the printer 30 with the back faces presented to the print heads.

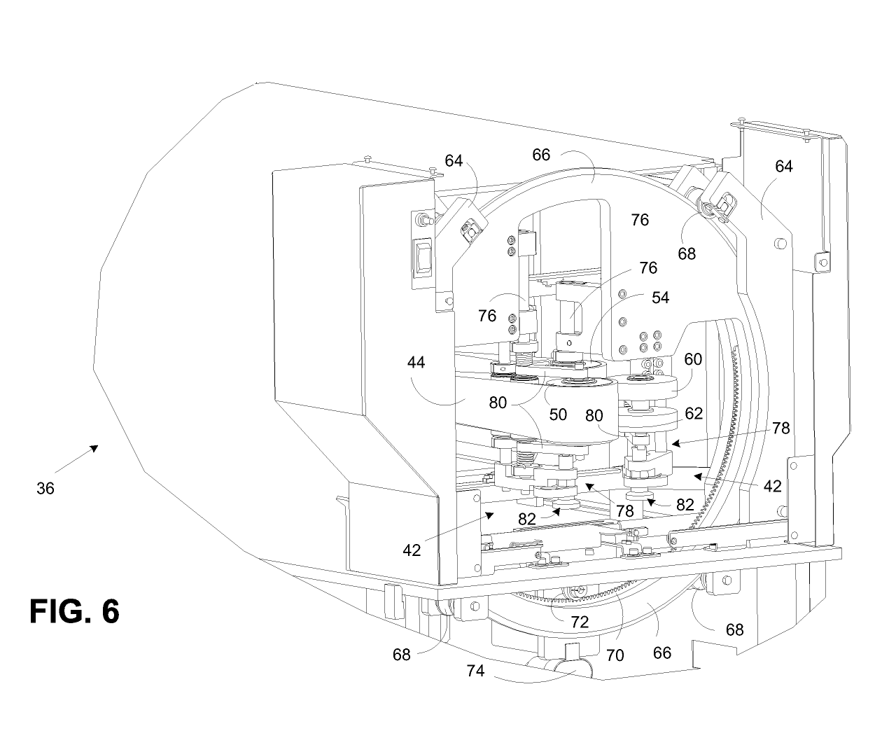

FIG. 6 shows the second portion 42 arranged to rotate the items approximately 90 degrees substantially about the transport axis A. Such an arrangement may have application where a user desires to transfer items from a component that processes the items in a “flat” orientation to another component configured for “on-edge” processing of items.

According to the invention, the second portion 42 may be moved as desired between the first position, for transporting items without changing their orientation, and a second position, for transporting items while rotating the items up to approximately 180 degrees substantially about the transport axis A.

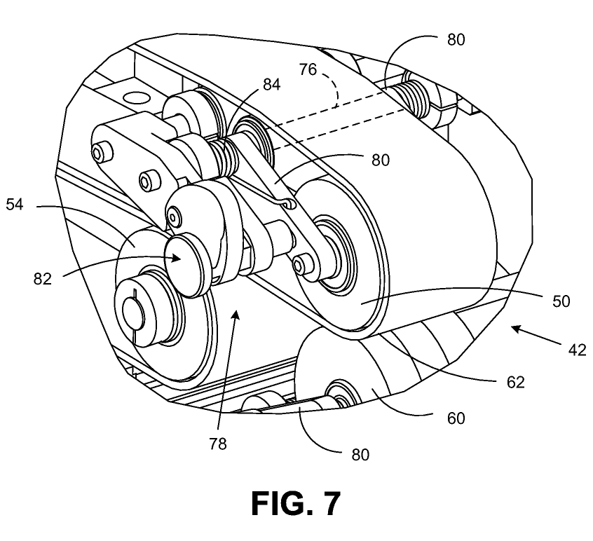

In one embodiment, shown in FIG. 7, the first end roller 50 and the nip roller 60 are each supported on the respective cantilevered shafts 76 on the guide 66 by a mounting assembly 78 comprising a link 80 pivotably mounted on the respective shaft 76 and a locking device 82 for selectively locking the link 80 to the respective shaft 76.

In the illustrated embodiment, the link 80 is biased with a torsion spring 84, which holds the respective roller in a “floating” configuration. Either roller 50, 60 may be locked with respect to its shaft 76 by engaging the locking device 82 with the respective link 80. In one example, one of the rollers 50, 60 is kept in the locked configuration and the other 60, 50 is kept in the floating configuration to accommodate the thickness of the items passing through the nip 62. When the second portion 42 is moved to a new position by rotating the guide 66, the rollers 50, 60 may be locked and unlocked accordingly.

It will be apparent to those skilled in the art that various modifications and variations can be made to the structure and methodology described herein. Thus, it should be understood that the invention is not limited to the examples discussed in the specification. Rather, the present invention is intended to cover modifications and variations.

What is claimed is:

1. A reconfigurable transport system, comprising:
a transport device for receiving items in a first orientation in one of a first portion and a second portion and releasing the items from the other of the first portion and the second portion, the transport device comprising:
at least one first transport element rotating around a plurality of first support rollers in a first direction; and
at least one second transport element in opposing relation to the at least one first transport element, the at least one second transport element rotating around a plurality of second support rollers in a second direction opposite to the first direction, wherein items received between the transport elements are conveyed along a transport axis; and
a positioning device for selectively moving the second portion between a first position in which the transport device maintains the items in the first orientation, and a second position in which the transport device rotates the items substantially about the transport axis to a second orientation.

2. The transport system of claim 1, wherein the positioning device comprises:
a stationary frame;
a selectively rotatable guide disposed on the frame;
a first gear element disposed on the guide;
a second gear element engaging the first gear element; and
a drive element for selectively driving the second gear element to rotate the guide, wherein rotation of the guide moves the second portion between the first position and the second position.

3. The transport system of claim 2, wherein the plurality of first support rollers comprises a first end roller, wherein the plurality of second support rollers comprises a second end roller, and wherein the transport device further comprises a nip roller forming a nip with the first end roller for engaging items passing therebetween.

4. The transport system of claim 3, wherein the first end roller, the second end roller, and the nip roller are supported on the guide on respective cantilevered shafts.

5. The transport system of claim 4, wherein the first end roller and the nip roller are each supported on the respective cantilevered shafts by a mounting assembly comprising:
a link pivotably mounted on the respective shaft; and
a locking device for selectively locking the link to the respective shaft.

6. The transport system of claim 2, wherein the first gear element comprises at least a portion of an annular gear, and wherein the second gear element comprises a pinion.

7. The transport system of claim 2, further comprising a plurality of support elements rotatably supporting the guide on the frame.

8. The transport system of claim 1, wherein the transport device with the second portion in the second position rotates the items approximately 180 degrees or less substantially about the transport axis.

9. The transport system of claim 8, wherein the transport device with the second portion in the second position rotates the items approximately 90 degrees substantially about the transport axis.

10. A reconfigurable transport system, comprising:
a transport device for receiving items in a first orientation in one of a first portion and a second portion and releasing the items from the other of the first portion and the second portion, the transport device comprising:
at least one first transport element rotating around a plurality of first support rollers in a first direction, wherein the plurality of first support rollers comprises a first end roller; and
at least one second transport element in opposing relation to the at least one first transport element, the at least one second transport element rotating around a plurality of second support rollers in a second direction opposite to the first direction, wherein the plurality of second support rollers comprises a second end roller, and wherein items received between the transport elements are conveyed along a transport axis;
a positioning device for selectively moving the second portion between a first position in which the transport device maintains the items in the first orientation, and a second position in which the transport device rotates the items substantially about the transport axis to a second orientation; and
a housing supporting the transport device and the positioning device.

11. The transport system of claim 10, wherein the positioning device comprises:
a frame supported on the housing;
a selectively rotatable guide disposed on the frame;
a first gear element disposed on the guide;
a second gear element engaging the first gear element; and
a drive element for selectively driving the second gear element to rotate the guide, wherein rotation of the guide moves the second portion between the first position and the second position.

12. The transport system of claim 11, wherein the transport device further comprises a nip roller forming a nip with the first end roller for engaging items passing therebetween.

13. The transport system of claim 12, wherein the first end roller, the second end roller, and the nip roller are supported on the guide on respective cantilevered shafts.

14. The transport system of claim 13, wherein the first end roller and the nip roller are each supported on the respective cantilevered shafts by a mounting assembly comprising:
a link pivotably mounted on the respective shaft; and
a locking device for selectively locking the link to the respective shaft.

15. The transport system of claim 11, wherein the first gear element comprises at least a portion of an annular gear, and wherein the second gear element comprises a pinion.

16. The transport system of claim 11, further comprising a plurality of support elements rotatably supporting the guide on the frame.

17. The transport system of claim 10, wherein the transport device with the second portion in the second position rotates the items approximately 180 degrees or less substantially about the transport axis.

18. The transport system of claim 17, wherein the transport device with the second portion in the second position rotates the items approximately 90 degrees substantially about the transport axis.

19. A method of conveying items in a reconfigurable transport system, the method comprising:
receiving the items in a first orientation in one of a first portion and a second portion of a transport device, wherein the transport device comprises:
at least one first transport element rotating around a plurality of first support rollers in a first direction; and
at least one second transport element in opposing relation to the at least one first transport element, the at least one second transport element rotating around a plurality of second support rollers in a second direction opposite to the first direction;
conveying the items between the transport elements along a transport axis;
selectively moving the second portion of the transport device between a first position in which the transport device maintains the items in the first orientation, and a second position in which the transport device rotates the items substantially about the transport axis to a second orientation; and
releasing the items from the other of the first portion and the second portion of the transport device.

20. The method of claim 19, wherein the items released from the transport device are in the first orientation.

21. The method of claim 19, wherein the transport device with the second portion in the second position rotates the items approximately 180 degrees or less substantially about the transport axis.

22. The method of claim 21, wherein the transport device with the second portion in the second position rotates the items approximately 90 degrees substantially about the transport axis.
